(19) United States
(12) Patent Application Publication
(10) Pub. No.: US 2015/0127353 A1
(43) Pub. Date: May 7, 2015

(54) ELECTRONIC APPARATUS AND METHOD FOR CONTROLLING ELECTRONIC APPARATUS THEREOF

(71) Applicant: SAMSUNG ELECTRONICS CO., LTD., Suwon-si (KR)

(72) Inventors: Nam-gook Cho, Suwon-si (KR); Ki-beom Kim, Yongin-si (KR); Jeong-su Kim, Yongin-si (KR); Hyun-kyu Yun, Seoul (KR)

(73) Assignee: SAMSUNG ELECTRONICS CO., LTD., Suwon-si (KR)

(21) Appl. No.: 14/400,220

(22) PCT Filed: May 8, 2013
(86) PCT No.: PCT/KR2013/003992

§ 371 Date: Nov. 10, 2014

(30) Foreign Application Priority Data
May 8, 2012 (KR) 10-2012-0048525

(51) Int. Cl. G10L 15/22

(52) U.S. Cl. CPC G10L 15/22; G10L 2015/223
USPC 704/275

(57) ABSTRACT

A method for controlling the electronic apparatus including: receiving an input of an audio which includes a user's voice; processing the audio and generating a user voice signal; transmitting the user voice signal to a first server; receiving text information corresponding to the user voice signal from the first server; and controlling the electronic apparatus, according to the text information.

### CROSS-REFERENCE TO RELATED PATENT APPLICATION

This application is a national stage entry under 35 U.S.C. §371(c) of International application of PCT/KR2013/003992, filed on May 8, 2013, and claims the benefit of priority Korean Patent Application No. 10-2012-0048525, filed in the Korean Patent Office on May 8, 2012, the disclosures of which are incorporated herein by reference in their entirety.

### BACKGROUND

1. Technical Field

Methods and apparatuses consistent with exemplary embodiments relate to an electronic apparatus and method for controlling the electronic apparatus thereof, and more particularly, to an electronic apparatus which may control functions of the electronic apparatus or search contents using a user's voice input through a voice input unit, and a method for controlling the electronic apparatus thereof.

2. Description of the Related Art

As electronic technologies develop, various types of electronic apparatuses are being provided. Various types of electronic apparatuses, including TVs, are being widely used in households. These electronic apparatuses have come to have various functions to satisfy user demands. For example, recent TVs are being connected to the internet to support internet services. In addition, users are able to view numerous digital broadcasting channels through TVs.

Accordingly, there is a need for various input methods for using various functions of electronic apparatuses efficiently. For example, input methods using a remote control, mouse, or touch pad are being applied to electronic apparatuses.

However, there have been difficulties in using the various functions of electronic apparatuses efficiently with just the aforementioned simple input methods. For example, if a remote control is made to control all the functions of an electronic apparatus, the number of buttons in the remote control will be increased. In this case, it is not easy for a general user to learn how to use the remote control. Furthermore, in a case where a user has to search and select a menu from various menus displayed on a screen, it is inconvenient for the user to search through a complex menu tree, and select the menu that he/she wants.

Therefore, recently, technologies using voice recognition are being developed to control electronic apparatuses more easily and intuitively. More specifically, recent electronic apparatuses are made to receive a user's voice through a voice input apparatus such as a microphone, search whether or not there is a command which corresponds to the user's voice in a prestored database, and control the electronic apparatus using the searched result.

However, in the case of using a database prestored in the electronic apparatus as used in the aforementioned conventional voice recognition method, storage capacity of the database is limited, and, therefore, only a limited number of commands are storable, which is a problem. Furthermore, in the case of receiving a voice signal through an apparatus such as the microphone, the user has to hold the microphone, which is inconvenient.

### SUMMARY

An aspect of the exemplary embodiments relates to an electronic apparatus which searches text information corresponding to a user's voice using an external server and is controlled according to the searched text information, and a method for controlling the same.

According to an exemplary embodiment of the present disclosure, a method for controlling an electronic apparatus may include receiving an input of an audio which includes a user's voice; processing the audio and generating a user voice signal; transmitting the user voice signal to a first server; receiving text information corresponding to the user voice signal from the first server; and controlling the electronic apparatus, according to the text information.

In addition, the controlling may include determining whether the text information is text information related to a control command or text information related to a search.

Furthermore, the determining may include determining that the text information is text information related to the control command if a prestored control command which corresponds to the received text information exists, and determining that the text information is text information related to the search if a prestored control command which corresponds to the received text information does not exist.

In addition, the controlling may include controlling the electronic apparatus according to the prestored control command corresponding to the text information, if it is determined that the text information is text information related to the prestored control command.

Furthermore, the method may further include generating a query corresponding to the text information; transmitting the query to a second server; receiving search information corresponding to the text information from the second server; and outputting the received search information, if it is determined that the text information is related to the search.

In addition, the generating the user voice signal may include determining whether an energy value of the input audio is greater than a predetermined energy value; removing noise included in the audio and extracting the user's voice from the audio if the input audio is greater than the predetermined energy value; and processing the extracted user's voice and generating the user voice signal.

Furthermore, the generating the user voice signal may include determining whether an energy value of the input audio is greater than a predetermined energy value; determining whether a predetermined keyword is included in the audio, if the energy value of the input audio is greater than the predetermined energy value; extracting the user's voice after the predetermined keyword from the audio, if the predetermined keyword is included in the audio; and signal processing the extracted user voice after the predetermined keyword and generating the user voice signal.

In addition, the receiving may include receiving the audio using an audio receiving device provided external to the electronic apparatus.

Furthermore, the audio receiving device may process the audio and generate the user voice signal, and the audio receiving device may transmit the generated user voice signal to the electronic apparatus.

According to an exemplary embodiment of the present disclosure, an electronic apparatus may include a voice input unit which receives an input of an audio including a user's voice, and processes the audio to generate a user voice signal; a communication unit which transmits the user voice signal to a first server, and receives text information corresponding to the user voice signal from the first server; and a control unit which controls the electronic apparatus, according to the text information.

In addition, the control unit may determine whether the text information is text information related to a control command or text information related to a search.

Furthermore, the apparatus may further include a storage unit which stores a command related to a control command, and the control unit may determine that the text information is text information related to the control command, if a command which corresponds to the received text information exists in the storage unit, and determine that the text information is text information related to the search, if a command which corresponds to the received text information does not exist in the storage unit.

Furthermore, the control unit may control the electronic apparatus according to the control command corresponding to the text information, if it is determined that the text information is text information related to the control command.

In addition, the apparatus may further include a display unit, and the control unit may generate a query corresponding to the text information, transmit the query to a second server, control the communication unit to receive search information corresponding to the text information from the second server, and output the received search information to the display unit, if it is determined that the text information is text information related to the search.

Furthermore, the voice input unit may include an energy determining unit which determines whether an energy value of the input audio is greater than a predetermined energy value; a noise removing unit which removes noise included in the audio and extracts a user's voice, if the energy value of the input audio is greater than the predetermined energy value; and a voice signal generating unit which processes the extracted user voice and generates the user voice signal.

In addition, the voice input unit may include an energy determining unit which determines whether an energy value of the input audio is greater than a predetermined energy value; a keyword determining unit which determines whether the audio includes a predetermined keyword if the energy value of the input audio is greater than a predetermined energy value, and which extracts a user's voice after the keyword if a predetermined keyword is included in the audio; and a voice signal generating unit which processes the user voice after the predetermined keyword and generates the user voice signal.

In addition, the voice input unit may be an audio receiving device provided external to the electronic apparatus.

Furthermore, the voice input unit may be a portable device wherein a microphone is provided.

According to one or more exemplary embodiments, the user becomes able to control the electronic apparatus 100 or search contents using various search words through a server where various search words are stored.

### BRIEF DESCRIPTION OF DRAWINGS

The above and/or other aspects of the present disclosure will be more apparent by describing certain exemplary embodiments with reference to the accompanying drawings, in which:

FIG. 1 is a view illustrating a composition of a voice recognition system according to an exemplary embodiment of the present disclosure,

FIG. 2 is a block diagram illustrating a composition of an electronic apparatus according to an exemplary embodiment of the present disclosure,

FIGS. 3 and 4 are block diagrams illustrating a composition of a voice input unit, according to various exemplary embodiments of the present disclosure,

FIG. 5 is a flowchart for explaining a method of controlling an electronic apparatus according to a user's voice input through a voice input unit, according to an exemplary embodiment of the present disclosure,

FIG. 6 is a flowchart for explaining a method of controlling an electronic apparatus according to a text information type according to an exemplary embodiment of the present disclosure, and

FIG. 7 is a view illustrating a composition of a voice recognition system, according to another exemplary embodiment of the present disclosure.

### DETAILED DESCRIPTION

Certain exemplary embodiments are described in higher detail below with reference to the accompanying drawings.

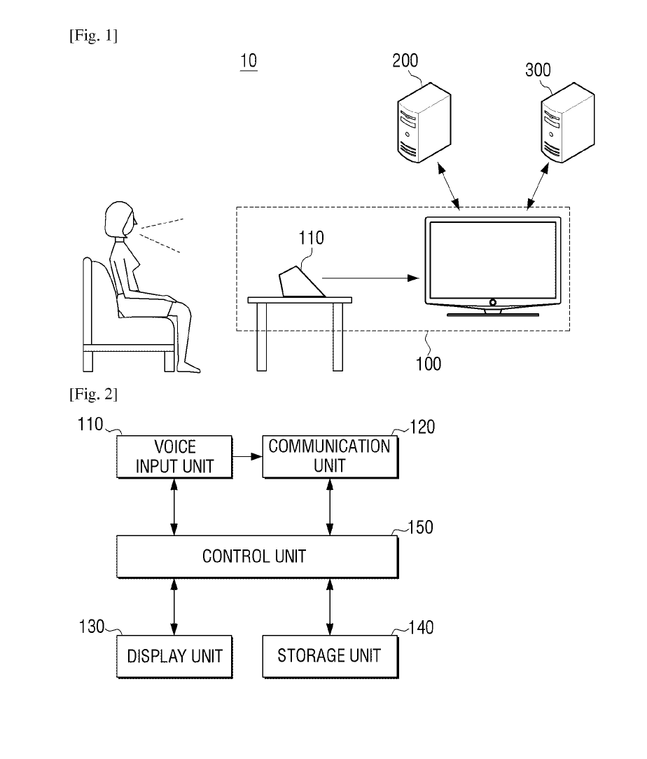

FIG. 1 is a view illustrating a voice recognition system 10, according to an exemplary embodiment of the present disclosure. As illustrated in FIG. 1, the voice recognition system 10 includes an electronic apparatus 100 which includes a voice input unit 110, i.e., a voice inputter, a first server 200 and a second server 300. Meanwhile, the electronic apparatus 100 according to an exemplary embodiment of the present disclosure may be a TV as illustrated in FIG. 1, but this is merely an example, and thus the electronic apparatus 100 may be a set top box, desk top PC, navigation device, and DVD player.

The electronic apparatus 100 receives an audio which includes a voice that a user through a voice input unit 110 provided externally. Herein, the voice input unit 110 is an apparatus which receives a voice that a user made within a predetermined distance (for example, 2˜3 m), and may be formatted to rest on a table instead of a microphone that a user has to hold with the user's hand.

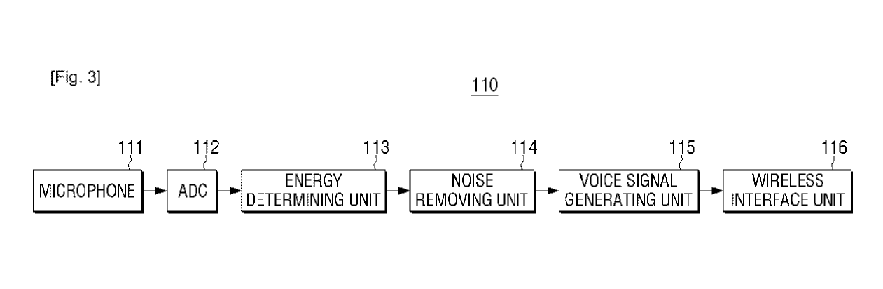

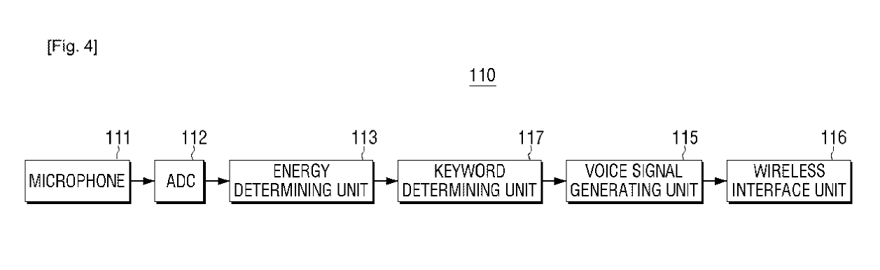

The electronic apparatus 100 processes the received audio and generates a user voice signal. More specifically, the electronic apparatus 100 may remove noise (for example, vacuum cleaner sound or air conditioner sound, etc.) and generate the user voice signal. Furthermore, the electronic apparatus 100 may process a portion of the user voice after a predetermined keyword and generate a user voice signal. A method of generating a user voice signal will be explained in more detail hereinafter with reference to FIGS. 3 and 4.

In addition, the electronic apparatus 100 transmits the generated user voice signal to an external first server 200.

When a voice signal is received from the electronic apparatus 100, the first server 200 searches for text information corresponding to the user voice signal, and transmits the searched text information to the electronic apparatus 100.

In addition, the electronic apparatus 100 controls functions of the electronic apparatus 100 according to the text information received from the first server 200. More specifically, the electronic apparatus 100 may determine whether the text information received from the first server 200 is text information related to a control command or text information related to a search. In a case where the received text information is text information related to a control command, the electronic apparatus 100 may control functions of the electronic apparatus 100 according to the control command corresponding to the text information. In a case where the received text information is text information related to a search, the electronic apparatus 100 generates a query using the text information, and transmits the query to the second server 300. In addition, the electronic apparatus 100 may receive the search information corresponding to the query from the second server 300 and output the search information.

By the aforementioned voice recognition system 10, the user is able to control functions of the electronic apparatus 100 or search contents information using various search words.

Hereinbelow is a detailed explanation of the electronic apparatus 100 with reference to FIGS. 2 to 4. FIG. 2 is a block diagram illustrating a composition of an electronic apparatus 100 according to an exemplary embodiment. As illustrated in FIG. 2, the electronic apparatus 100 includes a voice input unit 110, communication unit 120, i.e., a communicator, display unit 130, i.e., a display, storage unit 140, i.e., a storage, and control unit 150, i.e., a controller. In a case where the electronic apparatus 100 is a set top box, the electronic apparatus 100 may include an image output unit (not illustrated) instead of the display unit 130.

The voice input unit 110 receives an input of an audio signal where a user's voice is included, and processes the audio signal to generate a user voice signal. Herein, the voice input unit 110 may be provided outside a body of the electronic apparatus 100, as illustrated in FIG. 1. Furthermore, the voice input unit 110 may transmit the generated user voice signal to the body of the electronic apparatus 100 through a wireless interface (for example, Wi-Fi, Blue-tooth®, etc.).

A method of the voice input unit 110 receiving the audio signal which includes the user voice and generating the user voice signal will be explained with reference to FIGS. 3 and 4. FIG. 3 is a block diagram illustrating a composition of a voice input unit, according to an exemplary embodiment of the present disclosure. As illustrated in FIG. 3, the voice input unit 110 includes a microphone 111, ADC (Analog-Digital Converter) 112, energy determining unit 113, i.e., an energy determiner or a sound level determiner, noise removing unit 114, i.e., a noise remover, voice signal generating unit 115, i.e., a signal generator, and wireless interface unit 116.

The microphone 111 receives an input of an audio signal having an analog format where a user voice is included.

The ADC 112 converts a multi-channel analog signal input from the microphone into a digital signal.

The energy determining unit 113 calculates energy of the converted signal, i.e., an energy value or sound level, and determines whether or not the energy of the digital signal is the same or above a predetermined value, i.e., a predetermined energy value or a predetermined sound level. In a case where the energy of the digital signal is greater than or equal to the predetermined value, the energy determining unit 113 transmits the input digital signal to the noise removing unit 114, and in a case where the energy of the digital signal is less than the predetermined value, the energy determining unit 113 does not output the input digital signal but waits for another input. Accordingly, it is possible to prevent consumption of unnecessary power since the entire audio processing procedure is not activated by sound below the predetermined value.

In a case where the input digital signal is input to the noise removing unit 114, the noise removing unit 114 removes a noise component from the digital signal where the noise component and voice component are included. Herein, the noise component is sporadic noise that may occur in household environments, and may include air conditioner sound, vacuum cleaner sound, and music, etc. In addition, the noise removing unit 114 outputs the digital signal from which the noise component has been removed to the voice signal generating unit 115.

The voice signal generating unit 115 tracks a location where the user made the sound which exists within 360° from the voice input unit 110 using a Localization/Speaker Tracking module, and calculates direction information on the user's voice. The voice signal generating unit 115 may use the digital signal from which noise has been removed and the direction information on the user's voice to extract a sound source location which exists within 360° from the voice input unit 110. In addition, the voice signal generating unit 115 converts the user's voice into a user voice signal having a format to be transmitted to the electronic apparatus 100, and transmits the user voice signal to the body of the electronic apparatus 100 using the wireless interface.

FIG. 4 is a block diagram illustrating a composition of a voice input unit according to another exemplary embodiment of the present disclosure. As illustrated in FIG. 4, the voice input unit 110 includes a microphone 111, ADC (Analog-Digital Converter) 112, energy determining unit 113, keyword determining unit 117, voice signal generating unit 115, and wireless interface unit 116. Herein, explanation on the microphone 111, ADC 112, energy determining unit 113, voice signal generating unit 115, and wireless interface 116 is the same as in FIG. 3, and thus detailed explanation thereof will be omitted.

The keyword determining unit 117 determines whether or not a predetermined keyword exists in the input digital signal. Herein, the keyword is a command word (for example, galaxy) which signifies that a user has started voice recognition, which may be determined when manufacturing the electronic apparatus. However, this is merely an example, and the keyword may be changed by a setting by the user. In a case where a predetermined keyword exists in the input digital signal, the keyword determining unit 117 transmits the digital signal which includes the user's voice after the keyword, and in a case where a predetermined keyword does not exist in the input digital signal, the keyword determining unit 117 does not output the input digital signal but waits for another input.

In addition, the voice signal generating unit 115 may process the digital signal which includes the user's voice which has been input after the keyword as explained in FIG. 3, and transmits the processed digital signal to the body of the electronic apparatus 100 through the wireless interface 116.

As illustrated in FIG. 4, since the entire audio processes procedure is activated based on whether or not a predetermined keyword has been input, it becomes possible to prevent unnecessary voice recognition processing when a user does not intend to input to the voice input unit.

Referring to FIG. 2 again, the communication unit 120 performs communication with external servers 200, 300. More specifically, the communication unit 120 may transmit the user voice signal generated in the voice input unit 110 to the first server 200, and receive text information corresponding to the user voice signal from the first server 200. In addition, the communication unit 120 may transmits a query which includes text information related to a search to the second server 300, and receive search information from the second server 300.

Herein, the communication unit 120 may utilize Ethernet, wireless LAN, and Wi-Fi, etc., but it is not limited thereto.

The display unit 130 displays image data by a control of the control unit 150. Herein, the display unit 130 may display a search result corresponding to the user's voice.

The storage unit 140 stores various programs and data for driving the electronic apparatus. The storage unit 140 may include a voice recognition database which stores command words related to control commands.

The control unit 150 controls overall operations of the electronic apparatus 100 according to a user's control command. Especially, the control unit 150 may control overall operations of the electronic apparatus 100 according to the user's voice input through the voice input unit 110.

When text information corresponding to the user voice signal is received from the first server 200 through the communication unit 110, the control unit 150 determines whether or not the text information received from the first server 200 is text information related to the control command or text information related to a search. The text information related to the control command may be text information for controlling functions (for example, power control, channel change etc.) of the electronic apparatus 100 or changing setting (volume etc.), while the text information related to search may be text information (for example, title, keyword, main character, etc.) of the contents that the user intends to search.

Herein, the control unit 150 may determine whether or not a prestored control command exists in the storage unit 140 which corresponds to the text information received from the first server 200, to determine whether or not the text information corresponding to the user voice signal is text information related to the control command or text information related to search. More specifically, when there exists a prestored control command which corresponds to the received text information, the control unit 150 may determine that the text information is text information related to the control command, and if there does not exist a prestored control command which corresponds to the received text information, the control unit 150 may determine that the text information is text information related to the search.

When it is determined that the text information is text information related to a control command, the control unit 150 may control the electronic apparatus according to the control command corresponding to the text information. For example, in a case where the text information includes a command to change the channel, the control unit 150 may change the broadcasting channel to correspond to the text information.

When it is determined that the text information is text information related to the search, the control unit 150 may generate a query where the text information is included, and may control the communication unit 120 to transmit the query to the second server 300. In addition, when search information corresponding to the text information is received from the second server 300 through the communication unit 120, the control unit 150 may perform a parsing on the search information and output on the display unit 130. For example, when the text information includes a keyword on content A, the control unit 150 may receive search information related to content A from the second server 300 and display it.

Meanwhile, according to the aforementioned exemplary embodiment, it is possible to determine whether or not there exists a prestored control command in the storage unit 140 which corresponds to the text information received from the first server 200, but this is merely an exemplary embodiment, and thus the text type may be determined by other methods as well. For example, in a case where information on the text type is included in the text information received from the first server 200, it is possible to perform a parsing on the text information received from the first server 200 and determine the text type.

With the aforementioned electronic apparatus 100, the user is able to control the electronic apparatus 100 or search contents using various and complex words. Furthermore, the user is able to perform voice recognition using an audio receiving device provided external to the electronic apparatus 100 even without holding an additional microphone. That is, the user is able to control the electronic apparatus 100 in a hands-free state.

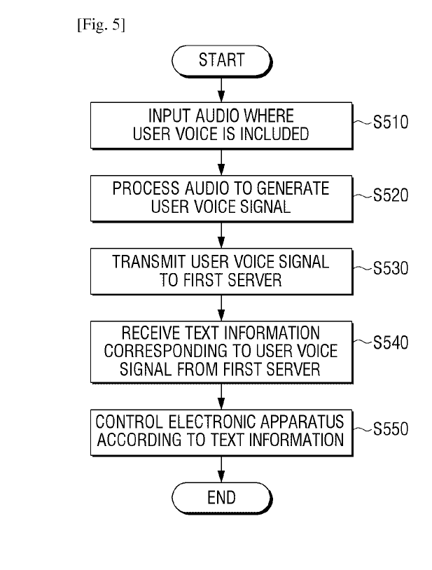

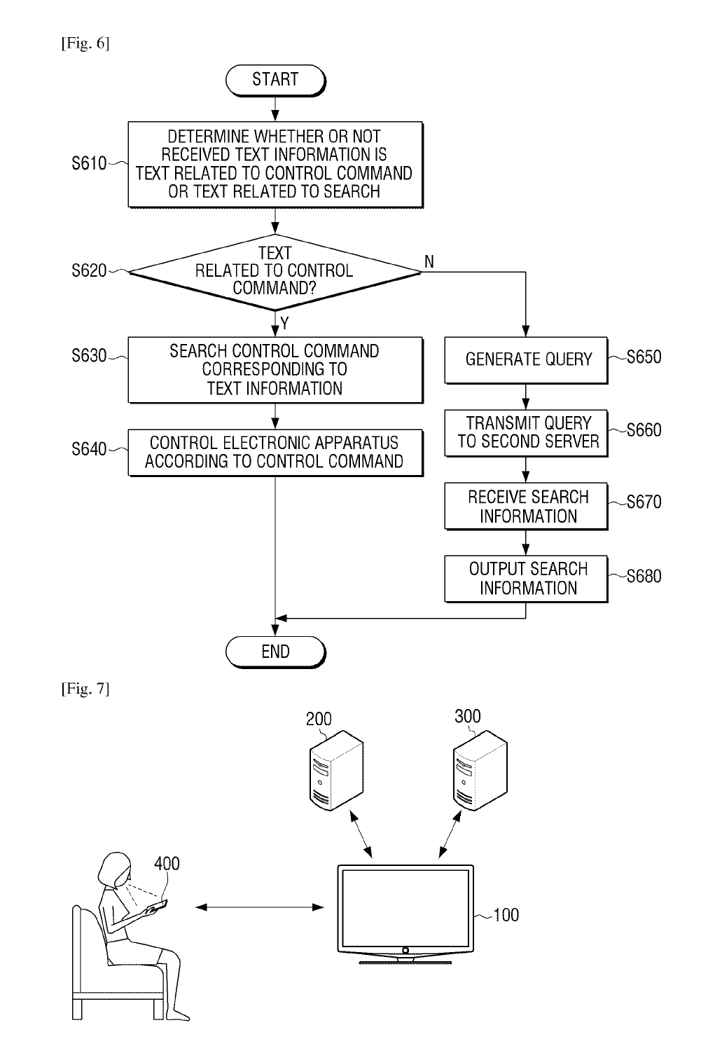

Hereinbelow is an explanation on a control method of the electronic apparatus 100 with reference to FIGS. 5 and 6. FIG. 5 is a flowchart for explaining a method for controlling an electronic apparatus according to a user's voice input through the voice input unit.

First of all, the electronic apparatus 100 receives an input of an audio where a user's voice is included (S510). Herein, as illustrated in FIG. 1, the electronic apparatus 100 may receive an input of an audio where a user's voice is included using an audio receiving device provided external to the electronic apparatus.

In addition, the electronic apparatus 100 processes the input audio and generates a user voice signal (S520). More specifically, as illustrated in FIG. 3, the electronic apparatus 100 may remove sporadic noise which is unnecessary for voice recognition from the input audio, and generate a user voice signal. In addition, the electronic apparatus 100 may determine whether or not a predetermined keyword is input and generate a user voice signal, as illustrated in FIG. 4. A method for generating a user voice signal was explained in FIGS. 3 and 4, and, thus, a detailed explanation will be omitted.

In addition, the electronic apparatus 100 transmits the user voice signal to the first server 200 (S530), and receives text information corresponding to the user voice signal from the first server 200 (S540).

In addition, the electronic apparatus 100 controls the electronic apparatus 100 according to the text information (S550). Herein, the electronic apparatus 100 may control the electronic apparatus 100 differently according to the type of the text information. A method for controlling the electronic apparatus according to the type of the text information will be explained with reference to FIG. 6.

First of all, the electronic apparatus 100 determines whether or not the received text information is a text related to a control command or a search (S610). More specifically, the electronic apparatus 100 may determine whether or not there exists a prestored control command which corresponds to the text information received from the first server 200, and determine whether or not the text information corresponding to the user voice signal is text information related to the prestored control command or related to search. If there exists a prestored control command which corresponds to the received text information, the electronic apparatus 100 may determine that the text information is text information related to the prestored control command, whereas if there does not exists a prestored control command that corresponds to the received text information, the electronic apparatus 100 may determine that the text information relates to the search.

In a case where it is determined that the received text information is information related to a control command (S620—Y), the electronic apparatus 100 searches a control command corresponding to the text information (S630).

In addition, the electronic apparatus 100 controls the electronic apparatus 100 according to the searched for control command (S640).

However, when it is determined that the received text information is information related not to a search (S620—N), the electronic apparatus 100 generates a query which includes the text information (S650).

In addition, the electronic apparatus 100 transmits the query where the text information is included to the second server 300 located external to the electronic apparatus 100 (S660).

In addition, the electronic apparatus 100 receives search information from the second server 300 (S670). Herein, the search information may include search results on the contents corresponding to the text information (for example, a URL, etc.).

In addition, the electronic apparatus 100 outputs the received search information (S680). Herein, if the electronic apparatus 100 includes a display unit 130 such as a TV, the electronic apparatus 100 may display the received search information on the display unit 130, and if the electronic apparatus 100 does not include a display unit 130 such as a set top box, the electronic apparatus 100 may output the received search information on a display device external to the electronic apparatus.

By the aforementioned control method of the electronic apparatus 100, the user becomes able to control the electronic apparatus 100 or search contents using more various search words through a server where various search words are stored.

Meanwhile, according to FIG. 1, the voice input unit 110 is an audio receiving device provided outside the main body of the electronic apparatus 110, but this is merely an example, and, thus, as illustrated in FIG. 7, a portable device 400 (for example, a smart phone, tablet PC, etc.) may include functions of the voice input unit. That is, the portable device 400 may receive an input of an audio which includes a user voice using a microphone, and may process the input audio signal and transmit the generated user voice signal to the electronic apparatus 100, as illustrated in FIGS. 3 and 4.

In a case where the portable device 400 includes functions of the voice input unit as illustrated in FIG. 7, the user is able to control functions of the electronic apparatus 100 or search contents using the user's voice without an additional audio receiving device. In addition, when using the portable device 400, since the user's voice is received from a short distance (for example, within 30 cm), the energy of the user's voice would be much greater that the energy of the noise, and thus various noises do not need to be considered.

A program code for performing a control method according to the aforementioned various exemplary embodiments may be stored in a non-transitory computer readable medium. A non-transitory computer readable medium does not refer to a medium which stores data for a short period of time such as a register, cache, or memory, but a computer readable medium which stores data semi-permanently. More specifically, the aforementioned various applications or programs may be stored in non-transitory computer readable media such as CD, DVD, hard disk, Blu-ray disk, USB, memory card, and ROM, etc.

Although a few exemplary embodiments of the present invention have been shown and described, it would be appreciated by those skilled in the art that changes may be made without departing from the principles and spirit of the invention, the scope of which is defined in the claims and their equivalents.

1. A method for controlling an electronic apparatus, the method comprising:
receiving an input of an audio which includes a user's voice;
processing the audio and generating a user voice signal;
transmitting the user voice signal to a first server;
receiving text information corresponding to the user voice signal from the first server; and
controlling the electronic apparatus, according to the text information.

2. The method according to claim 1, wherein the controlling comprises determining whether the text information is text information related to a control command or text information related to a search.

3. The method according to claim 2, wherein the determining comprises:
determining that the text information is text information related to the control command in response to a prestored control command corresponding to the received text information being stored in the electronic apparatus; and
determining that the text information is text information related to the search in response to a prestored control command corresponding to the received text information not being stored in the electronic apparatus.

4. The method according to claim 2, wherein the controlling comprises:
controlling, in response to determining that the text information is text information related to the prestored control command, the electronic apparatus according to the prestored control command corresponding to the text information.

5. The method according to claim 2, the method further comprising:
in response to determining that the text information is related to the search,
generating a query corresponding to the text information;
transmitting the query to a second server;
receiving search information corresponding to the text information from the second server; and
outputting the received search information.

6. The method according to claim 1, wherein the generating the user voice signal comprises:
determining whether an energy value of the input audio is greater than a predetermined energy value;
removing, in response to the energy value being greater than the predetermined energy value, noise included in the audio and extracting the user's voice from the audio; and
signal processing the extracted user's voice and generating the user voice signal.

7. The method according to claim 1, wherein the generating the user voice signal comprises:
determining whether an energy value of the input audio is greater than a predetermined energy value;
determining, in response to the energy value being greater than the predetermined energy value, whether a predetermined keyword is included in the audio;
extracting, in response to the predetermined keyword being included in the audio, the user's voice after the predetermined keyword from the audio; and
signal processing the extracted user voice after the predetermined keyword and generating the user voice signal.

8. The method according to claim 1, wherein the receiving comprises:
receiving the audio using an audio receiving device provided external to the electronic apparatus.

9. The method according to claim 8, wherein the
the audio receiving device processes the audio and generates the user voice signal, and
wherein the audio receiving device transmits the generated user voice signal to the electronic apparatus.

10. An electronic apparatus comprising:
a voice inputter configured to receive an input of an audio including a user's voice, and process the audio to generate a user voice signal;
a communicator configured to transmit the user voice signal to a first server, and to receive text information corresponding to the user voice signal from the first server; and
a controller configured to control the electronic apparatus, according to the text information.

11. The apparatus according to claim 10, wherein the controller is further configured to determine whether the text information is text information related to a control command or text information related to a search.

12. The apparatus according to claim 11, further comprising a storage configured to store a command related to a control command,
wherein the controller is further configured to, in response to the received text information corresponding to the stored command, determine that the text information is text information related to the control command, and to, in response to the received text information not corresponding to the stored command, determine that the text information is text information related to the search.

13. The apparatus according to claim 11, wherein the controller is further configured to, in response to determining that the text information is text information related to the control command, control
the electronic apparatus according to the control command corresponding to the text information.

14. The apparatus according to claim 11, further comprising a display,
wherein
the controller is further configured to, in response to determining that the text information is text information related to the search, generate a query corresponding to the text information, transmits the query to a second server, control the communicator to receive search information corresponding to the text information from the second server, and outputs the received search information to the display.

15. The apparatus according to claim 10, wherein the voice inputter comprises:
an energy determiner configured to determine whether an energy value of the input audio is greater than a predetermined energy value;
a noise remover configured to, in response to the energy value of the input audio being greater than the predetermined energy value, remove noise included in the audio and extract the user's voice; and
a voice signal generator configured to process the extracted user voice to generate the user voice signal.

16. An electronic apparatus comprising:
a voice inputter configured to receive an audio signal comprising a user voice signal;
a communicator configured to transmit the user voice signal to a first server, and to receive text information corresponding to the user voice signal from the first server; and
a controller configured to control the electronic apparatus based on the received text information.

17. The electronic apparatus according to claim 16, wherein the controller is further configured to determine whether a keyword is included in a first portion of the user voice signal and, in response to the keyword being included in the first portion of the user voice signal, transmit the user voice signal to the first server.

18. The electronic apparatus according to claim 16, further comprising:
a storage configured to store one at least one command word related to at least one control command,
wherein the controller is further configured to, in response to the received text information corresponding to one command word among the at least one command word, control the electronic apparatus to execute at least one control command related to the one command word.

19. The electronic apparatus according to claim 16, wherein the electronic apparatus is configured to receive the input audio signal from an external sound receiving device, the sound receiving device being configured to determine whether a sound level of an input audio is greater than a predetermined sound level, and to, in response to the sound level of the input audio being greater than the predetermined sound level, transmit the input audio to the electronic apparatus.

20. The electronic apparatus according to claim 18, wherein the controller is further configured to, in response to the received text information not corresponding to at least one of the at least one command word, generate a query comprising the text information, control the communicator transmit the query to a second server, and control the communicator to receive search information corresponding to the query from the second server.
